(19) United States
(12) Patent Application Publication
(10) Pub. No.: US 2026/0196010 A1
(43) Pub. Date: Jul. 9, 2026

(54) APPARATUS AND METHODS FOR TRACKING FEATURES WITHIN IMAGES

(71) Applicant: QUALCOMM Incorporated, San Diego, CA (US)

(72) Inventors: Ming LEI, Chengdu (CN); Bo HU, Chengdu (CN)

(21) Appl. No.: 19/131,922

(22) PCT Filed: Jan. 12, 2023
(86) PCT No.: PCT/CN2023/071856

§ 371 Date: May 21, 2025

(51) Int. Cl. G06V 10/25; G06T 7/73

(52) U.S. Cl. CPC G06V 10/25; G06T 7/73; G06T 2207/20088

(57) ABSTRACT

Methods, systems, and apparatuses are provided to track features across multiple images for use in various systems. For example, a computing device receives at least a first image and a second image captured by a camera, and detects a feature within each of the first image and the second image. The feature is located at a first feature position within the first image and at a second feature position within the second image. The computing device also receives a first sensor pose of the sensor used to capture the first image and a second sensor pose of the sensor used to capture the second image. The computing device determines a portion of third image based on the first sensor pose, the second sensor pose, the first feature position, and the second feature position. The computing device then generates feature detection data characterizing whether the feature is detected.

### BACKGROUND

### Field of the Disclosure

This disclosure relates generally to processes for tracking features and, more particularly, to tracking features within images for use in driving systems.

### Description of Related Art

Various applications rely on capturing images and tracking features across the captured images. For example, extended reality applications, such as augmented reality and mixed reality applications, may capture two-dimensional images, and may perform process to detect and track features across the two-dimensional images. In some applications, vehicles, such as autonomous vehicles, may operate with vehicle monitoring systems that, among other things, attempt to track features across images to enhance a driver's experience and safety. For example, vehicle monitoring systems may capture two-dimensional images of a vehicle's environment, and may perform processes to detect features within the captured images. The vehicle monitoring systems may attempt to track the detected features across multiple images captured while the vehicle moves about the environment to determine, and update, the location of the vehicle. In such examples, feature descriptors characterizing features are determined from the two-dimensional images and compared to a database of descriptors to determine the vehicle's location.

In these and other examples, for various reasons such as changing lighting conditions and object occlusion, the database may include multiple descriptors generated for the same features. As a result, traditional feature tracking processes may lose track of a feature when attempting to track across multiple images. For instance, by failing to track a same feature across an otherwise larger number images, traditional feature tracking processes may yield shorter feature track lengths than if the feature were tracked across the larger number of images. Moreover, the database may require additional memory resources to store the multiple descriptors generated for the same features, which may also result in a less accurate feature descriptor database.

### SUMMARY

According to one aspect, an apparatus comprises a memory, and a processor coupled to the memory. The processor is configured to receive a first image and a second image captured by at least one sensor. Further, the processor is configured to detect a feature within the first image and the second image, the feature located at a first feature position within the first image and at a second feature position within the second image. The processor is also configured to receive a first sensor pose of the at least one sensor used to capture the first image and a second sensor pose of at least one sensor used to capture the second image. Further, the processor is configured to generate feature detection data identifying whether the feature is detected within a portion of a third image based on the first sensor pose, the second sensor pose, the first feature position, and the second feature position.

According to another aspect, a method by at least one processor includes receiving a first image and a second image captured by at least one sensor. Further, the method includes detecting a feature within the first image and the second image, the feature located at a first feature position within the first image and at a second feature position within the second image. The method also includes receiving a first sensor pose of the at least one sensor used to capture the first image and a second sensor pose of at least one sensor used to capture the second image. Further, the method includes generating feature detection data identifying whether the feature is detected within a portion of a third image based on the first sensor pose, the second sensor pose, the first feature position, and the second feature position.

According to another aspect, a non-transitory, machine-readable storage medium storing instructions that, when executed by at least one processor, causes the at least one processor to perform operations that include receiving a first image and a second image captured by at least one sensor. Further, the operations include detecting a feature within the first image and the second image, the feature located at a first feature position within the first image and at a second feature position within the second image. The operations also include receiving a first sensor pose of the at least one sensor used to capture the first image and a second sensor pose of at least one sensor used to capture the second image. Further, the operations include generating feature detection data identifying whether the feature is detected within a portion of a third image based on the first sensor pose, the second sensor pose, the first feature position, and the second feature position.

### BRIEF DESCRIPTION OF DRAWINGS

FIG. 1 is a block diagram of an exemplary vehicle monitoring system, according to some implementations;

FIG. 2 is a block diagram illustrating exemplary portions of the advanced driver assistance system of FIG. 1, according to some implementations;

FIGS. 3A, 3B, and 3C illustrate bounding boxes within images captured with a sensor, according to some implementations;

FIGS. 4A, 4B, and 4C illustrate bounding boxes within captured images, according to some implementations;

FIG. 5 is a flowchart of an exemplary process for detecting a feature within an image, according to some implementations; and

FIG. 6 is a flowchart of an exemplary process for tracking a feature over multiple images, according to some implementations.

### DETAILED DESCRIPTION

While the features, methods, devices, and systems described herein may be embodied in various forms, some exemplary and non-limiting embodiments are shown in the drawings, and are described below. Some of the components described in this disclosure are optional, and some implementations may include additional, different, or fewer components from those expressly described in this disclosure.

The embodiments described herein are directed to a computing environment that tracks features across multiple images and generates a database of descriptors based on the tracking. For instance, the embodiments may determine that a feature is “lost,” (e.g., not detected within a subsequent image), and may perform processes to determine a search area within one or more subsequent images to attempt to detect the feature within the areas. If the feature is detected in the one or more subsequent images, the one or more subsequent images are added to a tracking sequence for the feature. If the feature is not detected within the one or more subsequent images, a feature descriptor for the feature is stored within the database.

For example, in some implementations, a vehicle monitoring system, such as an advanced driver assistance system (ADAS), may include a plurality of vehicles, such as autonomous vehicles, and a server-side computing system, such as a cloud computing system. The plurality of vehicles may perform simultaneous localization and mapping (SLAM) processes. To perform at least some of these SLAM processes, the plurality of vehicles may rely on a database of generated feature descriptors and corresponding coordinates (e.g., three-dimensional points). For instance, the cloud computing system may maintain a database of three-dimensional (3D) points (i.e., 3D points) where each three-dimensional point includes a feature descriptor (e.g., characterizing an object or part thereof) and a corresponding location (e.g., three-dimensional location) of the feature descriptor. To generate the database of 3D points, the plurality of vehicles may move through their respective environments capturing images, and performing any of the processes described herein to track features within the captured images, and to generate 3D points based on the tracked features.

For instance, a vehicle may capture an image, such as a two-dimensional (2D) image, and may detect a feature within the image. The vehicle may determine a coordinate (e.g., 3D coordinate) for the feature, and may generate a “track sequence” (e.g., in local memory) characterizing a frame number for the image, the feature, and the coordinate. The vehicle may capture one or more subsequent images, and may determine whether the feature is still within the one or more subsequent images. If the feature is detected within the one or more subsequent images, the vehicle may add the frame numbers of the one or more subsequent images to the track sequence for the feature. If the feature is not detected within the one or more subsequent images (e.g., the feature has been “lost”), the vehicle may perform any of the processes described herein to project the feature to a future image, and determine if the feature is detected in the future image.

For example, the vehicle may perform operations as described herein to determine a triangulation of two images where the feature was detected, where the triangulation is based on a pose (e.g., values characterizing position and/or rotation) of one or more sensors (e.g., cameras) that captured the images. For instance, the triangulation may include any suitable process for determining a point in 3D space given the point's positions within two or more images and the corresponding sensor's pose when capturing the two or more images. Based on the triangulation, the vehicle may determine an area of the future image (e.g., a bounding box) to search for the feature (e.g., 3D to 2D projection). In some examples, such as when the triangulation process fails, the vehicle may perform any operations as described herein to determine the area of the future image based on pixel positions of the feature within the two or more images (e.g., 2D to 2D prediction). The vehicle may then perform any of the feature matching processes as described herein to attempt to detect the feature within the determined area of the future image.

If the feature is detected within the future image, the frame numbers for the one or more subsequent images, and the future image, are added to the track sequence. If the feature is not detected within the future image, a 3D point for the feature is generated. The vehicle may transmit the generated 3D point to the cloud computing system to be added to the database of 3D points.

Based on the database of 3D points, the plurality of vehicles may perform SLAM processes to, for instance, determine a location of the vehicle within a map, such as a high-definition (HD) map. For instance, as each of the plurality of vehicles moves through an environment, they may capture images of their environment. To perform localization, the plurality of vehicles may receive one or more of the 3D points from the database of the cloud computing system, and may compare the feature descriptors of the 3D points to features detected within the captured images. Based on the comparisons, the plurality of vehicles may determine their respective location. These examples are merely exemplary, and other uses of the 3D point database, such as the use of the 3D point database for augmented reality and mixed reality applications, are also contemplated.

Among other advantages, the embodiments reduce storage requirements, such as database storage requirements for 3D points, at least by reducing the number of descriptors associated with a feature at a geographical location. Moreover, the embodiments may require less processing resources (e.g., power and time) for matching descriptors than conventional techniques, and may allow for the execution of more accurate and efficient SLAM processes. Persons of ordinary skill in the art having the disclosures herein may recognize these and other advantages of the embodiments as well.

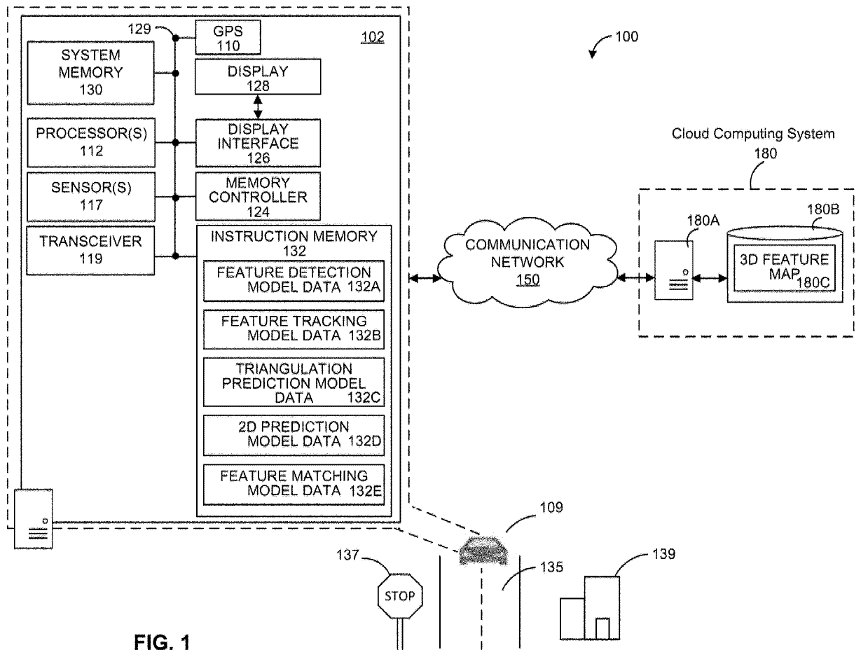

FIG. 1 is a block diagram of a vehicle monitoring system 100 that includes an advanced driver assistance system (ADAS) 102 for a vehicle 109 and a cloud computing system 180. Each of the ADAS system 102 and the cloud computing system 180 may be operatively connected to, and interconnected across, one or more communications networks, such as communication network 150. Examples of communication network 150 include, but are not limited to, a wireless local area network (LAN), e.g., a “Wi-Fi” network, a network utilizing radio-frequency (RF) communication protocols, a Near Field Communication (NFC) network, a wireless Metropolitan Area Network (MAN) connecting multiple wireless LANs, and a wide area network (WAN), e.g., the Internet.

It is to be appreciated that the specific configuration of components and communication interfaces between the different components shown in FIG. 1 are merely exemplary, and other configurations of the components, and/or other vehicle monitoring system with the same or different components, may be configured to implement the operations and processes of this disclosure.

As illustrated, cloud computing system 180 may include one or more servers 180A communicatively coupled to one or more data repositories 180B. Server 180A may be any suitable computing device. Further, each of the servers 180A are communicatively coupled to communication network 150. In addition, each data repository 180B may store data, such as 3D feature map 180C, that can be accessed by one or more servers 180A. As described herein, 3D feature map 180C may include feature descriptors and corresponding coordinates, such as 3D coordinates.

Further, ADAS system 102 may include one or more processors 112, one or more sensors 117, a transceiver 119, a Global Positioning System (GPS) device 110, a display interface 126 communicatively coupled to a display 128, a memory controller 124, a system memory 130, and instruction memory 132 configured to communicate with each other across bus 129. Bus 129 may include any of a variety of bus structures, such as a third-generation bus (e.g., a HyperTransport bus or an InfiniBand bus), a second-generation bus (e.g., an Advanced Graphics Port bus, a Peripheral Component Interconnect (PCI) Express bus, or an Advanced extensible Interface (AXI) bus), or another type of bus or device interconnect.

At least some of the functions of the ADAS system 102 may be implemented in one or more processors, one or more field-programmable gate arrays (FPGAs), one or more application-specific integrated circuits (ASICs), one or more state machines, digital circuitry, any other suitable circuitry, or any suitable hardware.

Processor(s) 112 may include any suitable processors, such as a central processing unit (CPU), a graphics processing unit (GPU), a microprocessor, or any other suitable processor. Processor(s) 112 may be configured to execute instructions to carry out one or more operations described herein. For instance, processor(s) 112 may read instructions from instruction memory 132, and execute the instructions to perform the operations.

Sensor 117 may include, for example, one or more optical sensors, such as cameras, configured to capture images of the vehicle's 109 environment. For instance, sensor 117 may be a camera configured to capture an image of the vehicle's 109 environment, such as an image of a stop sign 137, a building 139, and/or a roadway 135 (e.g., roadway markings) on which the vehicle 109 is travelling. In some examples, the camera may have a field-of-view in any direction with respect to vehicle 109, such as a forward-looking view, a backward-field-of-view, a sideways-field-of-view, an angled-filed of view, or any other suitable field-of-view. Sensor 117 may capture the image, and may store the image in a memory device (e.g., an internal memory device, system memory 130, etc.). Processor(s) 112 may obtain the captured image from the memory device or, in some examples, directly from sensor 117.

GPS device 110 may generate position data characterizing the vehicle's 109 position based on the GPS. Processor(s) 112 may receive data from GPS device 110 characterizing, for instance, a latitude and longitude of a location of GPS device 110. Further, transceiver 119 is configured to receive data from, and transmit data to, communication network 150. For instance, processor(s) 112 may provide data to transceiver 119 over bus 129 for transmission over communication network 150. Similarly, processor(s) 112 may obtain over bus 129 data received by transceiver 119. Additionally, display interface 126 is configured to output signals that cause graphical data to be displayed on a display 128 (e.g., dashboard display). For example, processor(s) 112 may provide image data to display interface 126 for displaying on display 128.

Memory controller 124 provides access to system memory 130 and to instruction memory 132. System memory 130 may store program modules and/or instructions and/or data that are accessible by processor(s) 112. For example, system memory 130 may store user applications (e.g., instructions for a camera application) and resulting images from sensor 117. System memory 130 may also store rendered images, such as three-dimensional (3D) images, rendered by processor(s) 112. System memory 130 may additionally store information for use by and/or generated by other components of ADAS system 102. For example, system memory 130 may act as a device memory for processor(s) 112. Examples of system memory 130 include one or more volatile or non-volatile memories or storage devices, such as RAM, SRAM, DRAM, EPROM, EEPROM, flash memory, a magnetic data media, a cloud-based storage medium, or an optical storage media.

Instruction memory 132 may store instructions that may be accessed (e.g., read) and executed by one or more processors 112. For example, instruction memory 132 may store instructions that, when executed by one or more processors 112, cause one or more of processors 112 to perform one or more of the operations described herein. For instance, instruction memory 132 can include instructions that, when executed by one or more of processors 112, cause one or more of processors 112 to apply one or more feature detection processes (e.g., machine learning processes) to a captured image to detect features, and to track the detected features over multiple images.

In this example, instruction memory 132 includes feature detection model data 132A, feature tracking model data 132B, triangulation prediction model data 132C, 2D prediction model data 132D, and feature matching model data 132E.

Feature detection model data 132A can include instructions that, when executed by one or more of processors 112, cause one or more of processors 112 to apply a feature detection process to an image, such as one captured by a sensor 117, to detect features within the image, and to generate feature descriptors characterizing the detected features. Further, feature tracking model data 132B can include instructions that, when executed by one or more of processors 112, cause one or more of processors 112 to track a feature among multiple images. For instance, when executed by the one or more of processors 112, feature tracking model data 132B may cause the one or more processors 112 to perform Kanade-Lucas-Tomasi (KLT) sparse optical flow tracking or descriptor matching tracking operations. In addition, feature tracking model data 132B can include instructions that, when executed by one or more of processors 112, cause one or more of processors 112 to generate feature tracking data identifying the images that include the feature.

Triangulation prediction model data 132C can include instructions that, when executed by one or more of processors 112, cause one or more of processors 112 to perform operations to determine a triangulation between two images based on a detected feature and, in some instances, a pose of a sensor that captured each image. Further, and based on the triangulation, the instructions, when executed by the one or more of processors 112, can cause the one or more of processors 112 to generate a bounding box characterizing an image area (e.g., pixel locations of an image).

Additionally, 2D prediction model data 132D can include instructions that, when executed by one or more of processors 112, cause one or more of processors 112 to generate a bounding box based on positions of features within two images. Further, feature matching model data 132E can include instructions that, when executed by one or more of processors 112, cause one or more of processors 112 to match features, such as features detected within an image captured by a sensor 117, to a database of features, such as features within 3D feature map 180C.

As an example, and to generate a database of features, such as 3D feature map 180C stored within data repository 180B, one or more vehicles may travel through one or more roadways 135 and capture images with one or more sensors 117. Each image may include, for instance, portions of the roadway 135 (e.g., road markings), portions of the stop sign 137, and/or portions of the building 139. Further, processor 112 may detect and generate features based on the captured images. For example, processor 112 may generate a feature descriptor for any detected features. As described herein, processor 112 may perform operations to track one or more of the features within images. For example, each vehicle 109 may maintain a “track sequence” for each feature. Each track sequence may identify a feature (e.g., a feature descriptor) and a number of images (e.g., a number of consecutive images) that include the feature. For instance, processor 112 may detect a feature within a captured image, and may add a feature descriptor generated for the feature, and a frame number of the image, to a track sequence for the feature.

In some examples, processor 112 further determines a pose of the sensor 117 when the sensor 117 captured the image. For instance, the processor 112 may have configured the sensor 117 to point in a specific direction (e.g., as defined by a 3D position), and may have stored sensor pose data in a memory device (e.g., system memory 130) characterizing the configuration. The processor 112 may read the sensor pose data from the memory device, may determine a pose of the sensor 117 based on the sensor pose data. In some examples, the processor 112 receives sensor pose data from the sensor 117 for the captured image, and determines the pose of the sensor based on the received sensor pose data. Processor 112 may add the pose of the sensor for the image to the track sequence for the feature.

The vehicle 109 (e.g., via one or more sensors 117) may capture subsequent images, and processor 112 may detect the feature within the subsequent images. Based on detecting the feature within the subsequent images, processor 112 may add the frame numbers of the subsequent images, and in some examples the pose of the sensor 117 when each of the subsequent images were captured, to the track sequence for the feature.

In some instances, the feature may be “lost.” For example, the vehicle 109 may capture an additional image, and processor 112 may not detect the feature within the additional image. For example, the feature may not have been detected due to object occlusion or illumination variation. To verify whether the image fails to include the feature, as described herein processor 112 may identify at least two previous images that include the feature (e.g., two images in which the feature was detected). Further, the processor 112 may perform operations (e.g., 3D-2D detection processes) to attempt to generate 3D point data characterizing one or more 3D points based on the two previous images and the sensor 117 pose corresponding to each of the two previous images. For instance, processor 112 may perform operations to determine an area of each of the two previous images (e.g., bounding boxes) that include the feature, and may triangulate a 3D image location based on the determined areas and the sensor pose for the sensor 117 when each of the two previous images were captured. For instance, the operations may include determining the 3D image location based on singular value decomposition (SVD) or principal component analysis (PCA) algorithms.

Additionally, processor 112 may determine a predicted area of the additional image that may include the feature based on the 3D point. For example, and based on the 3D image location, processor 112 may project the 3D image location to the additional image, and may generate a first bounding box that identifies an area of the additional image that includes the feature. The first bounding box may include a threshold number of pixels from the 3D image location in one or more directions (e.g., a threshold number of pixels up from, down from, to the right from, and to the left from, the 3D image location). For instance, processor 112 may apply a projection model process (e.g., 3D to 2D projection model process), such as a pinhole camera model process, to 3D image coordinates of the 3D image location and the pose of the sensor 117 (e.g., as defined by x, y, z coordinates with respect to the sensor's optical axis) to determine image coordinates within the additional image (e.g., project the 3D image location to the additional image). In some instances, processor 112 may apply a 2D prediction process to determine the image coordinates within the additional image. Processor 112 may then generate the first bounding box based on the determined image coordinates. In some instances, the size of the first bounding box depends on predetermined values, such as values characterizing uncertainties with 3D position or 2D prediction processes.

Based on the first bounding box, the processor 112 may perform feature matching operations to determine whether the additional image includes the feature. For instance, processor 112 may attempt to match the feature descriptor characterizing the feature to feature descriptors generated for any features detected at least partially within the area of the additional image associated with (e.g., defined by) the first bounding box. If the processor 112 matches the feature descriptor characterizing the feature to any feature descriptors generated for the additional image, the processor 112 adds the frame number of the additional image to the track sequence for the feature.

In some instances, such as when triangulation fails, processor 112 may perform additional operations to predict a position of the feature in an image based on the position of the feature within each of the at least two previous images (e.g., 2D-2D detection processes). For example, processor 112 may perform operations to determine a linear relationship between the areas of the two previous images that includes the feature. As described herein, the areas of the two previous images that include the feature may be associated with (e.g., defined by) a bounding box. In some instances, processor 112 generates linear data characterizing a line between the bounding boxes for the two previous images based on pixel coordinates of the bounding boxes. For example, processor 112 may determine a line according to ax+by+c=0, where a, b, and c are constants characterizing the line between the bounding boxes. Further, and based on the linear data, processor 112 determines a predicted area (e.g., pixel coordinate) of the additional image. For example, processor 112 may use a feature's coordinates to calculate a distance between the feature and the line. Features closer to the line (e.g., distance smaller than a predefined threshold) are considered more probable than features further from the line (e.g., distance greater than or equal to the predefined threshold). Processor 112 may determine the predicted area based on the calculated distances (e.g., the features with a distance smaller than the threshold).

Further, processor 112 may determine a second bounding box that includes the predicted area. The second bounding box may include a threshold number of pixels from the predicted area in one or more directions (e.g., a threshold number of pixels up from, down from, to the right from, and to the left from, the predicted area). In some instances, the second bounding box is larger than the first bounding box. For example, the second bounding box may define an area of the additional image that is larger than an area of the additional image defined by the first bounding box.

Based on the second bounding box, the processor 112 may perform feature matching operations to determine whether the additional image includes the feature. For instance, processor 112 may attempt to match the feature descriptor characterizing the feature to feature descriptors generated for any features detected at least partially within the area of the additional image defined by the second bounding box. In some examples, the processor 112 determines an epipolar line within the second bounding box. Processor 112 may determine the epipolar line based on the sensor pose corresponding to the two previous images (e.g., based on epipolar geometry algorithms). Further, the processor 112 may perform feature matching operations as described herein to attempt to match the feature within the second bounding box and along the epipolar line. If the processor 112 matches the feature descriptor characterizing the feature to any feature descriptors generated for the additional image, the processor 112 adds the frame number of the additional image to the track sequence for the feature.

If, however, the feature descriptor characterizing the feature is not matched to any feature descriptors generated for the additional image, processor 112 may attempt to similarly detect whether the feature is present within one or more images captured subsequent to the additional image. For instance, processor 112 may perform one or more of the detection processes (e.g., 2D-2D detection processes, 3D-2D detection processes) described herein to attempt to detect the feature in the one or more images up to a threshold number of images (e.g., up to 100 frames for images captured from a same sensor 117) using. If processor 112 matches the feature to any of these one or more images, the processor 112 adds the frame number of each of these one or more images (up to the image in which the feature was detected) to the track sequence for the feature. If, however, processor 112 fails to match the feature to any of these one or more images (e.g., the threshold number of captured images), processor 112 generates 3D point data charactering the feature based on the track sequence for the feature. In addition, processor 112 may transmit the 3D point data to the cloud computing system 180 for inclusion into 3D feature map 180C as a new feature.

As a result, the embodiments described herein may, among other advantages, reduce the amount of 3D points generated and stored within a 3D map, such as 3D feature map 180C, for any given feature. Moreover, and based on the generated 3D feature map 180C, vehicles 109 may receive 3D points from cloud computing system 180 to perform one or more SLAM operations, among others.

Although the components and the operations of FIG. 1 are described with respect to vehicle monitoring system 100, in other examples, other systems and/or devices may include the same or similar components and implement some or all of the operations described herein. For example, in some examples, an extended reality (XR) system, such as augmented reality (AR) system, a virtual reality (VR) system, or a mixed reality (MR) system, may generate a database of 3D points as described herein, and may employ the generated database during an XR, AR, VR, or MR application (e.g., gaming application).

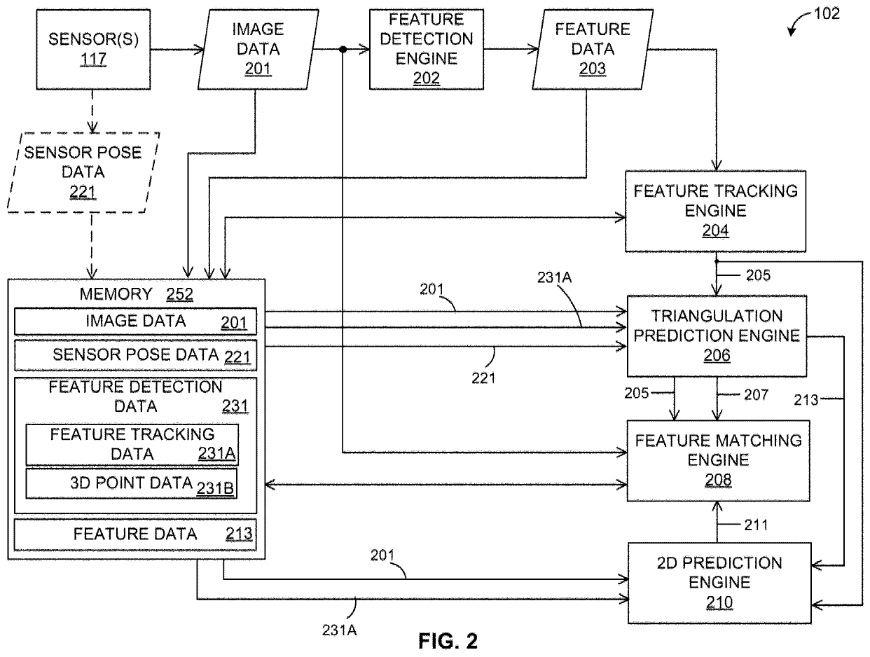

FIG. 2 is a diagram illustrating exemplary portions of the ADAS system 102 of FIG. 1. In some instances, one or more of the operations carried out by the ADAS system 102 are performed as part of a SLAM process. In this example, ADAS system 102 includes feature detection engine 202, feature tracking engine 204, triangulation prediction engine 206, feature matching engine 208, and 2D prediction engine 210. In some examples, each of feature detection engine 202, feature tracking engine 204, triangulation prediction engine 206, feature matching engine 208, and 2D prediction engine 210 may include instructions that, when executed by one or more processors 112, cause the one or more of processors 112 to perform corresponding operations. For example, feature detection engine 202 may include feature detection model data 132A, feature tracking engine 204 may include feature tracking model data 132B, triangulation prediction engine 206 may include triangulation prediction model data 132C, feature matching engine 208 may include feature matching model data 132E, and 2D prediction engine 210 may include 2D prediction model data 132D. In some examples, one or more of feature detection engine 202, feature tracking engine 204, triangulation prediction engine 206, feature matching engine 208, and 2D prediction engine 210 may be implemented in hardware, such as within one or more FPGAs, ASICs, digital circuitry, or any other suitable hardware or hardware or hardware and software combination.

In this example, one or more sensors 117 may capture images of a vehicle's 109 environment, and may generate image data 201 characterizing the captured image. The image data 201 may include metadata, such as a frame number, time of capture, and any other metadata. The sensors 117, in some examples, further provide sensor pose data 221 characterizing a pose of the sensor 117 when capturing the image. Sensor pose data 221 may be stored in any suitable memory (e.g., RAM, ROM, cloud-based storage), such as memory 252. In some examples, the sensors 117 may be configured by processor 112 to capture the images in a particular pose (e.g., a 3D position), and the configuration may be stored in memory 252.

Feature detection engine 202 may receive the image data 201, and may perform processes to detect features within the image data 201. For example, feature detection engine 202 may apply trained machine learning processes to the image data 201 to detect one or more features, such as portions of roadway 135, portions of the stop sign 137, and/or portions of the building 139. The trained machine learning process may be a Histogram of Oriented Gradients (HOG) feature detection process, a speeded up robust features (SURF) feature detection process, or any other suitable feature detection process.

Based on these feature detection processes, feature detection engine 202 may generate feature data 203 characterizing the detected features. For instance, feature data 203 may include feature descriptors characterizing the detected features and, in some instances, the frame number of the image data 201. Feature detection engine 202 may store feature data 203 within any suitable memory device, such as memory 252.

Feature tracking engine 204 may receive feature data 203 from feature detection engine 202, and may perform operations to track one or more features across multiple images. For instance, feature tracking engine 204 may perform operations to track features across multiple images based on KLT sparse optical flow tracking processes or descriptor matching tracking processes. As an example, feature tacking engine 204 may determine, for each feature identified within feature data 203, whether the feature is currently being tracked based on feature detection data 231 stored in memory 252. As described herein, feature detection data 231 may include feature tracking data 231A characterizing track sequences for corresponding features. For example, feature tracking data 231A may include, for each feature, a feature descriptor and frame numbers of images that include the feature. In some examples, feature tracking data 231A also includes sensor pose data 221 characterizing a pose of the sensor 117 used to capture the images.

Further, feature tacking engine 204 may compare feature descriptors received within feature data 203 to feature descriptors within feature tracking data 231A to determine whether a track sequence exists for a feature. If a track sequence has been established for a particular feature, feature tracking engine 204 may update the corresponding sequence with additional feature detection data 231, such as the frame number corresponding to image data 201. If, however, a track feature has not been established for a particular feature, feature tracking engine 204 may establish a track sequence for the feature, and store the generated track sequence within feature tracking data 231A of memory 252.

Further, and based on feature tracking data 231A, feature tracking engine 204 may determine if any features have been lost. For instance, feature tracking engine 204 may determine whether any features detected for a previous frame (e.g., as identified within feature data 203 for the last received image data 201) are not detected for the current frame (e.g., as identified within feature data 203 for the currently received image data 201). If feature tracking engine 204 determines that any features detected in a previous frame have not been detected in the current frame, feature tracking engine 204 generates feature lost data 205 that includes, for example, the feature descriptor for the lost feature. In some examples, feature tracking engine 204 generates the feature lost data 205 for a feature only after the feature has not been detected in a threshold number of images (e.g., within the image data 201 corresponding to 5, 10, 25, or any other number of consecutive images).

Triangulation prediction engine 206 may receive feature lost data 205 from feature tracking engine 204, and may perform operations to triangulate a 3D image location based on two previous images that include the feature, and the corresponding pose for the sensor 117 that captured the two previous images. For example, triangulation prediction engine 206 may obtain, from memory 252, image data 201 for two previous images that included the feature as identified by feature tracking data 231A for the corresponding feature. Further, triangulation prediction engine 206 may obtain sensor pose data 221 characterizing the pose of the sensor 117 when capturing each of the two previous images. Triangulation prediction engine 206 may determine, based on the image data 201 and the feature descriptors for the feature identified within feature tracking data 231A for each of the two previous images, a bounding box that includes the feature for each of the two previous images. In some examples, the two previous images are the last two images to include the feature.

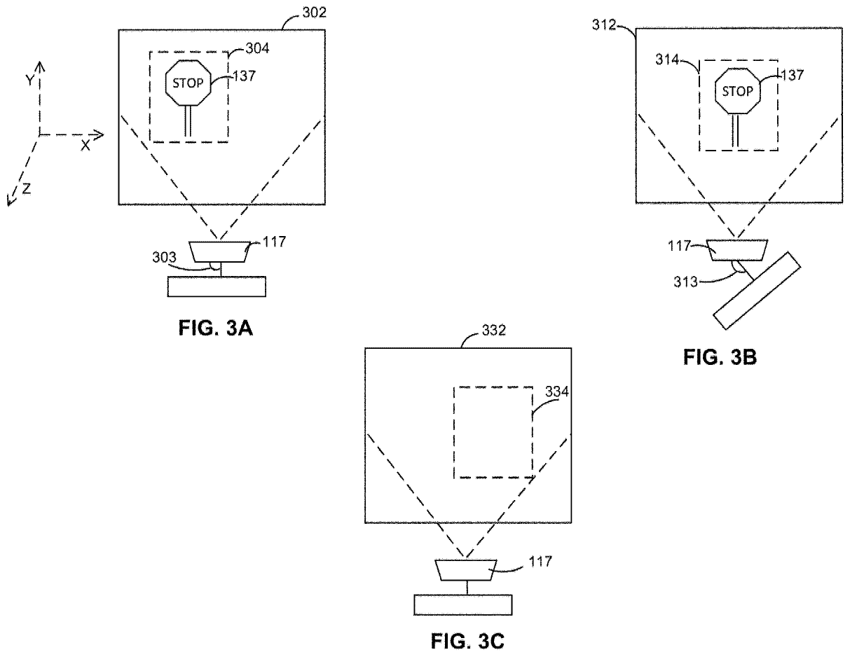

For instance, FIGS. 3A and 3B illustrate images 302, 322 captured with a sensor 117 positioned at varying poses. In FIG. 3A, sensor 117 captures image 302 at a first pose 303, while in FIG. 3B sensor 117 captures image 312 at a second pose 313. Each of the first pose 303 and the second pose 313 may be defined in a three-dimensional space (e.g., x, y, and z positions). Further, FIG. 3A illustrates the stop sign 137 within a first bounding box 304, while FIG. 3B illustrates the stop sign 137 within a second bounding box 314.

Referring back to FIG. 2, triangulation prediction engine 206 may perform a triangulation based on the bounding boxes for each of the two previous images and the pose of the sensor 117 used to capture each of the two previous images to generate a first predicted bounding box 207 characterizing a 3D image location. For example, FIG. 3C illustrates a predicted bounding box 334 generated for a current image 332. The predicted bounding box 334 is generated based on the first bounding box 304, the second bounding box 314, the first pose 303, and the second pose 313.

Feature matching engine 208 may receive the first predicted bounding box 207 from triangulation prediction engine 206 and the image data 201 for the current image, and may perform operations to match features identified within feature lost data 205 to the area of the image data 201 identified by the first predicted bounding box 207. For example, feature matching engine 208 may apply one or more trained machine learning processes to the area of the image data 201 associated with the first predicted bounding box 207 and the feature descriptors of the feature lost data 205 to determine whether the image data 201 includes the corresponding features. If feature matching engine 208 matches a feature, feature matching engine 208 may update the track sequence for the feature within feature tracking data 231A within memory 252 to include the frame number of the current image.

In some instances, such as when triangulation prediction engine 206 fails to triangulate between the two previous images with the feature (i.e., triangulation fails), 2D prediction engine 210 may perform operations to predict a position of the feature within image data 201 based on a position of the feature within each of the two previous images. For example, 2D prediction engine 210 may obtain image data 201 for each of the two previous images and the feature tracking data 231A for the feature from memory 252. Further, 2D prediction engine 210 may determine an area of each of the two previous images that includes the feature based on the feature tracking data 231A. For example, 2D prediction engine 210 may determine a bounding box for each of the two previous images, where each bounding box includes the feature. In some instances, each side of the bounding boxes is offset from the feature by a minimum number of pixels (e.g., 5, 10, etc.).

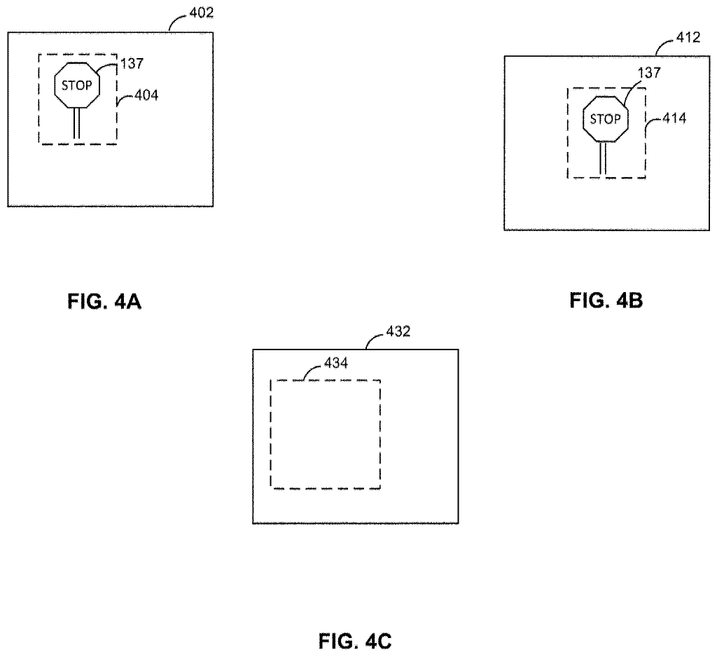

FIGS. 4A and 4B, for instance, illustrate a first image 402 and a second image 412 captured with a same sensor 117. Each of the first image 402 and the second image 414 include a stop sign 137. The stop sign 137 appears within different portions of the first image 402 and the second image 414 (e.g., due to vehicle 109 capturing the images 402, 412 while moving along a roadway). FIG. 4A illustrates a first image 402 with a first bounding box 404 that includes the stop sign 137, and FIG. 4B illustrates a second image 412 with a second bounding box 414 that includes the stop sign 137. As illustrated, first bounding box 404 defines an area that includes the stop sign 137, where each side of the first bounding box 404 is offset from the stop sign 137. Similarly, second bounding box 414 defines an area that includes the stop sign 137, where each side of the second bounding box 414 is offset from the stop sign 137.

Referring back to FIG. 2, 2D prediction engine 210 may determine a linear relationship, such as a line, between the areas of the two previous images that includes the feature. For example, 2D prediction engine 210 may generate linear data characterizing a line between the bounding boxes for the two previous images based on pixel coordinates of the bounding boxes. The line may be defined by a first pixel location in the center of the first bounding box, and a second pixel location in the center of the second bounding box. Further, and based on the linear data, 2D prediction engine 210 determines a position (e.g., pixel coordinate) of the feature within the image data 201 for the current image. For example, 2D prediction engine 210 may determine a position that is halfway along the line between the centers of the bounding boxes generated for the two previous images.

Additionally, based on the determined position, 2D prediction engine 210 generates a second predicted bounding box 211 characterizing a bounding box that identifies a predicted image area of the feature. For example, the second predicted bounding box 211 may characterize a bounding box that includes sides with a middle distanced at least a threshold number of pixels from the determined position (e.g., a threshold number of pixels up from, down from, to the right of, and to the left of, the determined position). In some instances, second predicted bounding box 211 is larger than the first predicted bounding box 207.

For instance, FIG. 4C illustrates a second predicted bounding box 434 generated for an image 432. The second predicted bonging box 435 is generated based on a determined linear relationship between the first bounding box 404 and the second bounding box 414. For instance, a center of the second predicted bounding box 434 may correspond to a pixel position that is anywhere along a line (e.g., halfway) between the center of the first bounding box 404 and the center of the second bounding box 414. In addition, a middle of each side of the second predicted bounding box 434 may be offset from the center of the second predicted bounding box 434 by a threshold number of pixels.

Referring back to FIG. 2, feature matching engine 208 may receive the second predicted bounding box 211 from 2D prediction engine 210, and may perform operations to match feature descriptors identified within feature lost data 205 to the area of the image data 201 identified by the second predicted bounding box 211. For example, feature matching engine 208 may apply one or more trained machine learning processes to the area of the image data 201 defined by the second predicted bounding box 211 and the feature descriptors of the feature lost data 205 to determine whether the image data 201 includes the corresponding features. In some examples, feature matching engine 208 determines an epipolar line within the second predicted bounding box 211, and performs the feature matching operations as described herein along the epipolar line. If feature matching engine 208 matches a feature, feature matching engine 208 may update the track sequence for the feature within feature tracking data 231A within memory 252 to include the frame number of the current image.

If, however, feature matching engine 208 fails to match the feature descriptors identified within feature lost data 205 to any features identified within an area of image data 201 defined by first predicted bounding box 207 or second predicted bounding box 211, ADAS system 102 may attempt to similarly detect whether the feature is present within one or more additional images captured subsequent to the additional image. For instance, feature detection engine 202, feature tracking engine 204, triangulation prediction engine 206, 2D prediction engine 210, and feature matching engine 208 may perform one or more of the processes described above to match the feature descriptors within one or more additional images captured by sensors 117 up to a threshold number of images. The threshold number of images may be stored in memory 252 and configured by a user, for instance.

If feature matching engine 208 matches a feature descriptor to any of the one or more images, feature matching engine 208 updates the feature tracking data 231A for the corresponding feature by adding the frame number of each of these one or more images to the track sequence up to the image in which the feature was matched. If, however, ADAS system 102 fails to match the feature to any of these one or more images (e.g., the threshold number of captured images), feature matching engine 208 generates 3D point data 231B charactering the feature based on the track sequence for the feature, and stores the 3D point data 231B within memory 252. ADAS system 102 may transmit the 3D point data 231B to the cloud computing system 180 for inclusion into 3D feature map 180C as a new feature (e.g., via transceiver 119). In some examples, ADAS system 102 transmits any newly generated 3D point data 231B to the cloud computing system 180 on a periodic interval (e.g., every 5 minutes, every hour, every 24 hours, every week, every month, etc.).

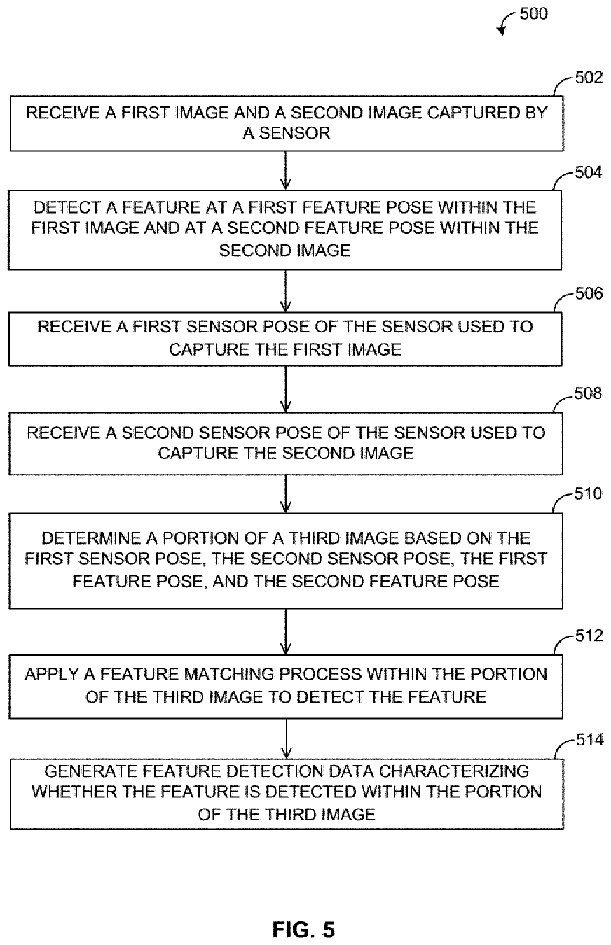

FIG. 5 is a flowchart of an exemplary process 500 for detecting a feature within an image. For example, one or more processors, such as processor 112 of ADAS system 102, may perform one or more operations of exemplary process 500, as described below in reference to FIG. 5.

Referring to FIG. 5, at block 502, processor 112 may receive a first image and a second image captured by a sensor. For example, processor 112 may receive image data 201 from sensor 117 for a first image, and may also receive image data 201 from sensor 117 for a second image. Further, at block 504, processor 112 may detect a feature at a first feature position within the first image. The processor 112 may also detect the feature at a second feature position within the second image. For instance, processor 112 may perform any feature detection processes as described herein to detect a feature (e.g., a portion of stop sign 137) within an area of the first image, and to detect the feature within an area of the second image.

Proceeding to block 506, processor 112 may receive a first sensor pose (e.g., position and/or rotation) of the sensor used to capture the first image. At block 508, processor 112 may receive a second sensor pose of the sensor used to capture the second image. For example, processor 112 may obtain sensor pose data 221 for the sensor 117 when capturing each of the first image and the second image. In some instances, processor 112 may obtain sensor configuration data from a memory device, such as memory 252, where the sensor configuration data characterizes the sensor pose of the sensor 117 when capturing the first image and the second image. For example, the sensor configuration data may identify a configured pose of the sensor 117 when capturing the first image, and a configured pose of the sensor 117 when capturing the second image.

At block 510, processor 112 determines a portion of a third image based on the first sensor position, the second sensor position, the first feature position, and the second feature position. The third image may be a current image, for example. To determine the portion of the third image, for instance, processor 112 may determine a 3D point based on a triangulation of the first and second images using the positions of the detected feature within the first and second images (e.g., first feature position and second feature position). Further, processor 112 may project the 3D point to the third image, and may generate a bounding box, such as predicted bounding box 207, based on the 3D point, where the bounding box is associated with the portion of the third image to search for the feature. In some instances, the bounding box is defined by sides that are offset by a threshold number of pixels from the 3D point.

Further, at block 512, processor 112 applies any of the feature matching processes described herein to the portion of the third image to detect the feature. For example, processor 112 may apply one or more trained machine learning processes to the portion of the third image associated with the bounding box and to a feature descriptor characterizing the feature to determine whether the third image includes the feature.

The processor 112, at block 514, generates feature detection data characterizing whether the feature is detected within the portion of the third image. For example, if the feature is detected within the portion of the third image, processor 112 may update feature tracking data 321A of feature detection data 231 within memory 252 to include the frame number of the current image. If the feature is not detected within the portion of the third image, processor 112 may perform operations to attempt to detect the feature in a subsequent image (e.g., if a number of consecutive images where the feature has not been detected has not reached a predetermined threshold), or may generate 3D point data 231B characterizing a new 3D data map for inclusion in a 3D feature map, such as 3D feature map 180C of cloud computing system 180 (e.g., if the number of consecutive images where the feature has not been detected has reached the predetermined threshold).

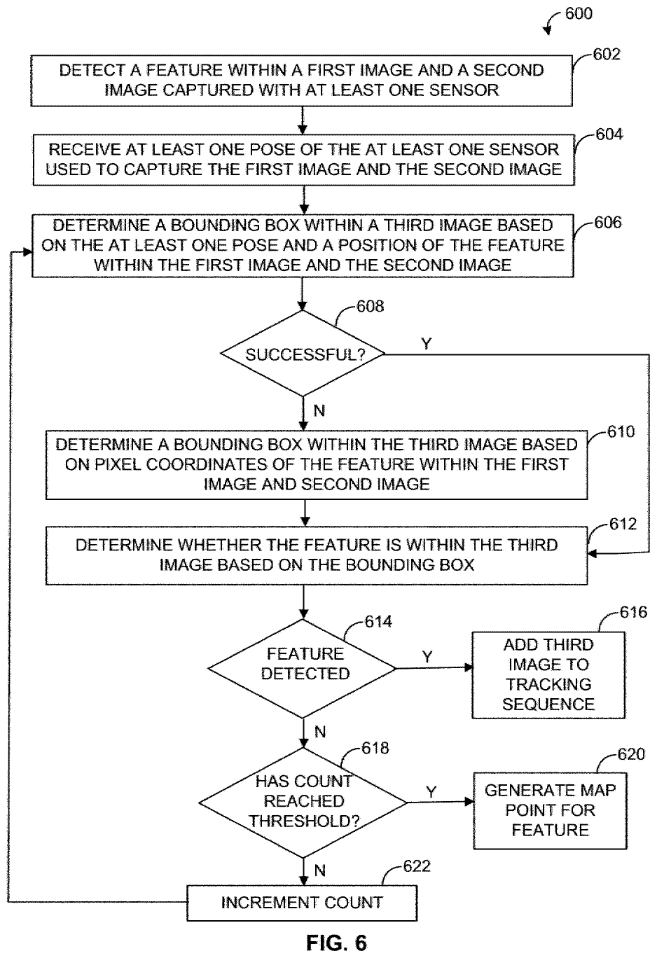

FIG. 6 is a flowchart of an exemplary process 600 for tracking a feature over multiple images. For example, one or more processors, such as processor 112 of ADAS system 102, may perform one or more operations of exemplary process 600, as described below in reference to FIG. 6.

Referring to FIG. 6, at block 602 processor 112 detects a feature within a first image and a second image captured with at least one sensor. For example, processor 112 may receive, from a sensor 117, image data 201 for a first image, and may detect a feature within the image data 201. The processor 122 may receive from the sensor 117 additional image data 201 for a second image captured subsequent to the first image. The processor 112 may detect the same feature within the additional image data 201.

At block 604, processor 112 receives at least one pose of the at least one sensor used to capture the first image and the second image. For example, processor 112 may receive sensor pose data 221 characterizing the sensor's 117 pose when the first image was captured. Processor 112 may also receive additional sensor pose data 221 characterizing the sensor's 117 pose when the second image was captured.

Further, and at block 606, processor 112 determines a bounding box for a third image based on the at least one pose and a position of the feature within the first image and the second image. The third image may be received subsequent to the first image and second image. For example, and as described herein, processor 112 may determine a 3D point based on a triangulation of the first image and the second image using the positions of the feature within the images. Further, processor 112 may project the 3D point to the third image, and may generate a bounding box, such as predicted bounding box 207, based on the 3D point. If, at block 608, processor 112 determines that the bounding box was successfully generated (e.g., triangulation successful), the method proceeds to block 612. Otherwise, if processor 112 determines that the bounding box was not successfully generated (e.g., triangulation failed), the method proceeds from block 608 to block 610.

At block 610, processor 112 determines an additional bounding box for the third image based on pixel coordinates of the feature within the first image and the second image. For example, and as described herein, processor 112 may determine a linear relationship between areas of the first image and the second image that include the feature. For instance, processor 112 may generate linear data characterizing a line between bounding boxes that define the feature areas of the first image and the second image. Further, and based on the linear data, processor 112 determines the additional bounding box for the third image. For example, processor 112 may generate the additional bounding box such that its center is positioned at a pixel coordinate anywhere along the line, such as halfway between the bounding boxes that define the feature areas of the first image and the second image. The method then proceeds to block 612.

Further, at block 612, processor 112 determines whether the feature is within the third image based on the bounding box (i.e., either the bounding box generated at block 606 or the bounding box generated at block 610). For instance, processor 112 may apply any of the feature matching processes described herein to the portion of the third image to detect the feature. In some examples, such as when the bounding box is generated at block 610, or when the bounding box defines an image area larger than a threshold amount, processor 212 may determine an epipolar line within the bounding box based on the first and second images, and may perform feature matching operations as described herein to attempt to match the feature within the bounding box along the epipolar line (e.g., as opposed to anywhere within the bounding box).

If, at block 614, processor 112 detects the feature within the third image, the method proceeds to block 616 where the third image is added to a track sequence for the feature. For instance, processor 112 may update feature tracking data 231A for the feature to include the frame number of the third image. If, however, processor 112 does not detect the feature within the third image, the method proceeds to block 618.

At block 618, processor 112 determines whether an image count has reached a threshold value. For example, processor 112 may maintain the image count within a memory device, such as memory 252. Processor 112 may obtain the image count from the memory device, and may compare the image count to a threshold value. If the image count has reached the threshold value (e.g., is the same as or greater than the threshold value), the method proceeds to block 620 where processor 112 generates a map point for the feature. For instance, processor 112 may generate a 3D point that includes a feature descriptor for the feature, and identifies 3D coordinates for the feature. In some instances, ADAS system 102 transmits the 3D point to the cloud computing system 180 for inclusion into 3D feature map 180C.

If, however, at block 618 the image count has not reached the threshold value (e.g., is less than the threshold value), the method proceeds to block 622, where processor 113 increments the image count. The method then proceeds back to block 606 to determine a bounding box for the next image.

Implementation examples are further described in the following numbered clauses:
1 An apparatus comprising:
a memory; and
a processor coupled to the memory, the processor configured to:
   receive a first image and a second image captured by at least one sensor;
   detect a feature within the first image and the second image, the feature located at a first feature position within the first image and at a second feature position within the second image;
   receive a first sensor pose of the at least one sensor used to capture the first image and a second sensor pose of at least one sensor used to capture the second image;
   and
   generate feature detection data identifying whether the feature is detected within a portion of a third image based on the first sensor pose, the second sensor pose, the first feature position, and the second feature position.
2. The apparatus of clause 1, wherein the processor is further configured to:
determine a triangulation between the first image and the second image based on the first sensor position, the second sensor position, the first feature position, and the second feature position;
determine a three-dimensional image location based on the triangulation; and
determine the portion of the third image based on the three-dimensional image location.
3. The apparatus of clause 2, wherein the processor is further configured to generate a bounding box based on the three-dimensional image location, wherein the bounding box is associated with the portion of the third image.
4. The apparatus of clause 3, wherein the processor is further configured to project the three-dimensional image location to the third image, and generate the bounding box based on the projected three-dimensional image location.
5. The apparatus of any of clauses 1-4, wherein the feature detection data identifies that the feature was detected, and wherein the processor is further configured to:
determine a frame number for the third image; and
store the frame number within a tracking sequence for the feature.
6. The apparatus of clause 5, wherein the processor is further configured to:
determine at least an additional frame number for at least an additional image, the third image and the at least additional image being captured by the at least one sensor, the at least additional image being captured prior to the third image; and store the frame number for the at least additional image within the tracking sequence for the feature.
7. The apparatus of any of clauses 1-6, wherein the feature detection data identifies that the feature was not detected, and wherein the processor is further configured to:
determine a linear relationship between the first image and the second image based on the first feature position and the second feature position;
determine a second portion of the third image based on the linear relationship; and
apply the feature matching process to the second portion of the third image to detect the feature.
8. The apparatus of clause 7, wherein to determine the linear relationship, the processor is further configured to:
determine a first bounding box based on the first feature position;
determine a second bounding box based on the second feature position;
determine a line between the first bounding box and the second bounding box; and
generate a predicted bounding box based on the line between the first bounding box and the second bounding box, the predicted bounding box defining the second portion of the third image.
9. The apparatus of any of clauses 7-8, wherein the processor is further configured to:
determine an epipolar line within the second portion of the third image; and apply the feature matching process along the epipolar line to detect the feature.
10. The apparatus of any of clauses 7-9, wherein the processor is further configured to:
determine the feature is not within the second portion of the third image based on the feature matching process;
generate three-dimensional point data characterizing the feature and a three-dimensional position of the feature; and
transmit the three-dimensional point data for inclusion in a three-dimensional feature map.
11. The apparatus of clause 10, wherein the processor is further configured to:
apply the feature matching process to each of a plurality of additional images;
based on the application of the feature matching process to each of the plurality of additional images, determine that the plurality of additional images do not include the feature;
determine that a total number of the third image and the plurality of additional images satisfies a predetermined value; and
based on the determination, generate the three-dimensional point data.
12. A method by at least one processor, the method comprising:
receiving a first image and a second image captured by at least one sensor;
detecting a feature within the first image and the second image, the feature located at a first feature position within the first image and at a second feature position within the second image;
receiving a first sensor pose of the at least one sensor used to capture the first image and a second sensor pose of at least one sensor used to capture the second image;
and
generating feature detection data identifying whether the feature is detected within a portion of a third image based on the first sensor pose, the second sensor pose, the first feature position, and the second feature position.
13. The method of clause 12, comprising:
determining a triangulation between the first image and the second image based on the first sensor position, the second sensor position, the first feature position, and the second feature position;
determining a three-dimensional image location based on the triangulation; and
determining the portion of the third image based on the three-dimensional image location.
14. The method of clause 13, comprising generating a bounding box based on the three-dimensional image location, wherein the bounding box is associated with the portion of the third image.
15. The method of clause 14, comprising projecting the three-dimensional image location to the third image, and generating the bounding box based on the projected three-dimensional image location.
16. The method of any of clauses 12-15, wherein the feature detection data identifies that the feature was detected, the method comprising:
determining a frame number for the third image; and
storing the frame number within a tracking sequence for the feature.
17. The method of clause 16, comprising:
determining at least an additional frame number for at least an additional image, the third image and the at least additional image being captured by the at least one sensor, the at least additional image being captured prior to the third image; and
storing the frame number for the at least additional image within the tracking sequence for the feature.
18. The method of any of clauses 12-17, wherein the feature detection data identifies that the feature was not detected, the method comprising:
determining a linear relationship between the first image and the second image based on the first feature position and the second feature position;
determining a second portion of the third image based on the linear relationship; and
applying the feature matching process to the second portion of the third image to detect the feature.
19. The method of clause 18, wherein to determine the linear relationship, the method comprises:
determining a first bounding box based on the first feature position;
determining a second bounding box based on the second feature position;
determining a line between the first bounding box and the second bounding box; and
generating a predicted bounding box based on the line between the first bounding box and the second bounding box, the predicted bounding box defining the second portion of the third image.
20. The method of any of clauses 18-19, comprising:
determining an epipolar line within the second portion of the third image; and applying the feature matching process along the epipolar line to detect the feature.
21. The method of any of clauses 18-20, comprising:
determining the feature is not within the second portion of the third image based on the feature matching process;
generating three-dimensional point data characterizing the feature and a three-dimensional position of the feature; and
transmitting the three-dimensional point data for inclusion in a three-dimensional feature map.
22. The method of clause 21, comprising:
applying the feature matching process to each of a plurality of additional images;
based on the application of the feature matching process to each of the plurality of additional images, determining that the plurality of additional images do not include the feature;
determining that a total number of the third image and the plurality of additional images satisfies a predetermined value; and
based on the determination, generating the three-dimensional point data.
23. A non-transitory, machine-readable storage medium storing instructions that, when executed by at least one processor, cause the at least one processor to perform operations that include:
receiving a first image and a second image captured by at least one sensor;
detecting a feature within the first image and the second image, the feature located at a first feature position within the first image and at a second feature position within the second image;
receiving a first sensor pose of the at least one sensor used to capture the first image and a second sensor pose of at least one sensor used to capture the second image;
and
generating feature detection data identifying whether the feature is detected within a portion of a third image based on the first sensor pose, the second sensor pose, the first feature position, and the second feature position.
24. The non-transitory, machine-readable storage medium of clause 23, wherein the instructions, when executed by the at least one processor, cause the at least one processor to perform operations that include:
determining a triangulation between the first image and the second image based on the first sensor position, the second sensor position, the first feature position, and the second feature position;
determining a three-dimensional image location based on the triangulation; and
determining the portion of the third image based on the three-dimensional image location.
25. The non-transitory, machine-readable storage medium of clause 24, wherein the instructions, when executed by the at least one processor, cause the at least one processor to perform operations that include generating a bounding box based on the three-dimensional image location, wherein the bounding box is associated with the portion of the third image.
26. The non-transitory, machine-readable storage medium of clause 25, wherein the instructions, when executed by the at least one processor, cause the at least one processor to perform operations that include projecting the three-dimensional image location to the third image, and generating the bounding box based on the projected three-dimensional image location.
27. The non-transitory, machine-readable storage medium of any of clauses 23-26, wherein the feature detection data identifies that the feature was detected, and wherein the instructions, when executed by the at least one processor, cause the at least one processor to perform operations that include:
determining a frame number for the third image; and
storing the frame number within a tracking sequence for the feature.
28. The non-transitory, machine-readable storage medium of clause 27, wherein the instructions, when executed by the at least one processor, cause the at least one processor to perform operations that include:
determining at least an additional frame number for at least an additional image, the third image and the at least additional image being captured by the at least one sensor, the at least additional image being captured prior to the third image; and
storing the frame number for the at least additional image within the tracking sequence for the feature.
29. The non-transitory, machine-readable storage medium of any of clauses 23-28, wherein the feature detection data identifies that the feature was not detected, and wherein the instructions, when executed by the at least one processor, cause the at least one processor to perform operations that include:
determining a linear relationship between the first image and the second image based on the first feature position and the second feature position;
determining a second portion of the third image based on the linear relationship; and
applying the feature matching process to the second portion of the third image to detect the feature.
30. The non-transitory, machine-readable storage medium of clause 29, wherein to determine the linear relationship, the instructions, when executed by the at least one processor, cause the at least one processor to perform operations that include:
determining a first bounding box based on the first feature position;
determining a second bounding box based on the second feature position;
determining a line between the first bounding box and the second bounding box; and
generating a predicted bounding box based on the line between the first bounding box and the second bounding box, the predicted bounding box defining the second portion of the third image.
31. The non-transitory, machine-readable storage medium of any of clauses 29-30, wherein the instructions, when executed by the at least one processor, cause the at least one processor to perform operations that include:
determining an epipolar line within the second portion of the third image; and
applying the feature matching process along the epipolar line to detect the feature.
32. The non-transitory, machine-readable storage medium of any of clauses 29-31, wherein the instructions, when executed by the at least one processor, cause the at least one processor to perform operations that include:
determining the feature is not within the second portion of the third image based on the feature matching process;
generating three-dimensional point data characterizing the feature and a three-dimensional position of the feature; and
transmitting the three-dimensional point data for inclusion in a three-dimensional feature map.
33. The non-transitory, machine-readable storage medium of clause 32, wherein the instructions, when executed by the at least one processor, cause the at least one processor to perform operations that include:
applying the feature matching process to each of a plurality of additional images;
based on the application of the feature matching process to each of the plurality of additional images, determining that the plurality of additional images do not include the feature;
determining that a total number of the third image and the plurality of additional images satisfies a predetermined value; and
based on the determination, generating the three-dimensional point data.
34. A device comprising:
a means for receiving a first image and a second image captured by at least one sensor;
a means for detecting a feature within the first image and the second image, the feature located at a first feature position within the first image and at a second feature position within the second image;
a means for receiving a first sensor pose of the at least one sensor used to capture the first image and a second sensor pose of at least one sensor used to capture the second image;
and
a means for generating feature detection data identifying whether the feature is detected within a portion of a third image based on the first sensor pose, the second sensor pose, the first feature position, and the second feature position.
35. The device of clause 34, comprising:
a means for determining a triangulation between the first image and the second image based on the first sensor position, the second sensor position, the first feature position, and the second feature position;
a means for determining a three-dimensional image location based on the triangulation; and
a means for determining the portion of the third image based on the three-dimensional image location.
36. The device of clause 35, comprising a means for generating a bounding box based on the three-dimensional image location, wherein the bounding box is associated with the portion of the third image.
37. The device of clause 36, comprising a means for projecting the three-dimensional image location to the third image, and generate the bounding box based on the projected three-dimensional image location.
38. The device of any of clauses 34-37, comprising:
a means for determining a frame number for the third image; and
a means for storing the frame number within a tracking sequence for the feature.
39. The device of clause 38, comprising:
a means for determining at least an additional frame number for at least an additional image, the third image and the at least additional image being captured by the at least one sensor, the at least additional image being captured prior to the third image; and
a means for storing the frame number for the at least additional image within the tracking sequence for the feature.
40. The device of any of clauses 34-39, comprising:
a means for determining a linear relationship between the first image and the second image based on the first feature position and the second feature position;
a means for determining a second portion of the third image based on the linear relationship; and
a means for applying the feature matching process to the second portion of the third image to detect the feature.
41. The device of clause 40, comprising:
a means for determining a first bounding box based on the first feature position;
a means for determining a second bounding box based on the second feature position;
a means for determining a line between the first bounding box and the second bounding box; and
a means for generating a predicted bounding box based on the line between the first bounding box and the second bounding box, the predicted bounding box defining the second portion of the third image.
42. The device of any of clauses 40-41, comprising:
a means for determining an epipolar line within the second portion of the third image; and
a means for applying the feature matching process along the epipolar line to detect the feature.
43. The device of any of clauses 40-42, comprising:
a means for determining the feature is not within the second portion of the third image based on the feature matching process;
a means for generating three-dimensional point data characterizing the feature and a three-dimensional position of the feature; and
a means for transmitting the three-dimensional point data for inclusion in a three-dimensional feature map.
44. The device of clause 43, comprising:
a means for applying the feature matching process to each of a plurality of additional images;
based on the application of the feature matching process to each of the plurality of additional images, a means for that the plurality of additional images do not include the feature;
a means for determining that a total number of the third image and the plurality of additional images satisfies a predetermined value; and
based on the determination, a means for generating the three-dimensional point data.

Although the methods described above are with reference to the illustrated flowcharts, many other ways of performing the acts associated with the methods may be used. For example, the order of some operations may be changed, and some embodiments may omit one or more of the operations described and/or include additional operations.

In addition, the methods and system described herein may be at least partially embodied in the form of computer-implemented processes and apparatus for practicing those processes. The disclosed methods may also be at least partially embodied in the form of tangible, non-transitory machine-readable storage media encoded with computer program code. For example, the methods may be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, computer program code segments configure the processor to create specific logic circuits. The methods may alternatively be at least partially embodied in application specific integrated circuits for performing the methods.

The subject matter has been described in terms of exemplary embodiments. Because they are only examples, the claimed inventions are not limited to these embodiments. Changes and modifications may be made without departing the spirit of the claimed subject matter. It is intended that the claims cover such changes and modifications.

We claim:

1. An apparatus comprising:
a memory; and
a processor coupled to the memory, the processor configured to:
receive a first image and a second image captured by at least one sensor;
detect a feature within the first image and the second image, the feature located at a first feature position within the first image and at a second feature position within the second image;
receive a first sensor pose of the at least one sensor used to capture the first image and a second sensor pose of at least one sensor used to capture the second image;
and
generate feature detection data identifying whether the feature is detected within a portion of a third image based on the first sensor pose, the second sensor pose, the first feature position, and the second feature position.

2. The apparatus of claim 1, wherein the at least one processor is further configured to:
determine a triangulation between the first image and the second image based on the first sensor position, the second sensor position, the first feature position, and the second feature position;
determine a three-dimensional image location based on the triangulation; and
determine the portion of the third image based on the three-dimensional image location.

3. The apparatus of claim 2, wherein the at least one processor is further configured to generate a bounding box based on the three-dimensional image location, wherein the bounding box is associated with the portion of the third image.

4. The apparatus of claim 3, wherein the at least one processor is further configured to project the three-dimensional image location to the third image, and generate the bounding box based on the projected three-dimensional image location.

5. The apparatus of claim 1, wherein the feature detection data identifies that the feature was detected, and wherein the at least one processor is further configured to:
determine a frame number for the third image; and
store the frame number within a tracking sequence for the feature.

6. The apparatus of claim 5, wherein at least one processor is configured to:
determine at least an additional frame number for at least an additional image, the third image and the at least additional image being captured by the at least one sensor, the at least additional image being captured prior to the third image; and
store the frame number for the at least additional image within the tracking sequence for the feature.

7. The apparatus of claim 1, wherein the feature detection data identifies that the feature was not detected, and wherein the at least one processor is further configured to:
determine a linear relationship between the first image and the second image based on the first feature position and the second feature position;
determine a second portion of the third image based on the linear relationship; and
apply the feature matching process to the second portion of the third image to detect the feature.

8. The apparatus of claim 7, wherein to determine the linear relationship, the at least one processor is configured to:
determine a first bounding box based on the first feature position;
determine a second bounding box based on the second feature position;
determine a line between the first bounding box and the second bounding box; and
generate a predicted bounding box based on the line between the first bounding box and the second bounding box, the predicted bounding box defining the second portion of the third image.

9. The apparatus of claim 7, wherein the at least one processor is configured to:
determine an epipolar line within the second portion of the third image; and
apply the feature matching process along the epipolar line to detect the feature.

10. The apparatus of claim 7, wherein the at least one processor is configured to:
determine the feature is not within the second portion of the third image based on the feature matching process;
generate three-dimensional point data characterizing the feature and a three-dimensional position of the feature; and
transmit the three-dimensional point data for inclusion in a three-dimensional feature map.

11. The apparatus of claim 10, wherein the at least one processor is configured to:
apply the feature matching process to each of a plurality of additional images;
based on the application of the feature matching process to each of the plurality of additional images, determine that the plurality of additional images do not include the feature;
determine that a total number of the third image and the plurality of additional images satisfies a predetermined value; and
based on the determination, generate the three-dimensional point data.

12. A method by at least one processor, the method comprising:
receiving a first image and a second image captured by at least one sensor;
detecting a feature within the first image and the second image, the feature located at a first feature position within the first image and at a second feature position within the second image;
receiving a first sensor pose of the at least one sensor used to capture the first image and a second sensor pose of at least one sensor used to capture the second image;
and
generating feature detection data identifying whether the feature is detected within a portion of a third image based on the first sensor pose, the second sensor pose, the first feature position, and the second feature position.

13. The method of claim 12, comprising:
determining a triangulation between the first image and the second image based on the first sensor position, the second sensor position, the first feature position, and the second feature position;
determining a three-dimensional image location based on the triangulation; and
determining the portion of the third image based on the three-dimensional image location.

14. The method of claim 13, comprising generating a bounding box based on the three-dimensional image location, wherein the bounding box is associated with the portion of the third image.

15. The method of claim 12, wherein the feature detection data identifies that the feature was detected, the method comprising:
determining a frame number for the third image; and
storing the frame number within a tracking sequence for the feature.

16. The method of claim 15, comprising:
determining at least an additional frame number for at least an additional image, the third image and the at least additional image being captured by the at least one sensor, the at least additional image being captured prior to the third image; and
storing the frame number for the at least additional image within the tracking sequence for the feature.

17. The method of claim 12, wherein the feature detection data identifies that the feature was not detected, the method comprising:
determining a linear relationship between the first image and the second image based on the first feature position and the second feature position;
determining a second portion of the third image based on the linear relationship; and
applying the feature matching process to the second portion of the third image to detect the feature.

18. The method of claim 17, wherein applying the feature matching process to the second portion of the third image comprises:
determining an epipolar line within the second portion of the third image; and
applying the feature matching process along the epipolar line to detect the feature.

19. The method of claim 17, comprising:
determining the feature is not within the second portion of the third image based on the feature matching process;
generating three-dimensional point data characterizing the feature and a three-dimensional position of the feature; and
transmitting the three-dimensional point data for inclusion in a three-dimensional feature map.

20. A non-transitory, machine-readable storage medium storing instructions that, when executed by at least one processor, cause the at least one processor to perform operations that include:
receiving a first image and a second image captured by at least one sensor;
detecting a feature within the first image and the second image, the feature located at a first feature position within the first image and at a second feature position within the second image;
receiving a first sensor pose of the at least one sensor used to capture the first image and a second sensor pose of at least one sensor used to capture the second image;
and
generating feature detection data identifying whether the feature is detected within a portion of a third image based on the first sensor pose, the second sensor pose, the first feature position, and the second feature position.
